(19) United States
(12) Patent Application Publication
(10) Pub. No.: US 2025/0264392 A1
(43) Pub. Date: Aug. 21, 2025

(54) APPARATUS AND METHODS FOR LIQUID-DESICCANT CONCENTRATION MEASUREMENT WITHIN MASS TRANSFER ASSEMBLIES

(71) Applicant: BLUE FRONTIER INC., Boca Raton, FL (US)

(72) Inventors: Daniel A. BETTS, Parkland, FL (US); Matthew TILGHMAN, Pennington, NJ (US); Matthew GRAHAM, West Palm Beach, FL (US); Dean WIERSMA, Fort Collins, CO (US)

(73) Assignee: BLUE FRONTIER INC, Boca Raton, FL (US)

(21) Appl. No.: 19/057,609

(22) Filed: Feb. 19, 2025

Related U.S. Application Data
(60) Provisional application No. 63/555,649, filed on Feb. 20, 2024.

(51) Int. Cl. G01N 9/26; B01D 53/14

(52) U.S. Cl. CPC G01N 9/26; B01D 53/1425

(57) ABSTRACT

The disclosure relates to heating ventilation and cooling systems that use liquid desiccant to remove moisture from air. In some examples, a system is configured to measure the density of a liquid. The system includes a measuring column having an inlet and an outlet. The inlet is a predetermined distance below the outlet, and the outlet is adapted such that liquid exits the outlet to low pressure. The system also includes a pressure sensor located proximate the inlet. Further, the system includes a processor adapted for receiving a reading from the pressure sensor and calculating a density of liquid flowing through the system using the reading.

### CROSS-REFERENCE TO RELATED APPLICATIONS

This application claims the benefit of priority to U.S. Provisional Patent Application No. 63/555,649, filed on Feb. 20, 2024, the entire disclosure of which is expressly incorporated herein by reference to its entirety.

### TECHNICAL FIELD

The disclosure relates generally to device and method for making measurements of the concentration of a solute in a liquid (e.g., a salt in a liquid desiccant) flowing within a system.

### BACKGROUND

Heating ventilation and air conditioning (HVAC) systems generally cool ambient or room temperature air using a vapor compression refrigeration cycle. The HVAC systems may include a heat exchanger that operates to remove heat from a refrigerant. For example, the heat exchanger may include plates or coils through which the refrigerant flows. A fan may blow air across the plates or coils to cool the refrigerant flowing within. Some heat exchangers include a liquid desiccant to dehumidify the air during the cooling process. The liquid desiccant may include a solute. The concentration of the solute can affect all aspects of the performance of the system. Thus, it is important to monitor the concentration of the solute in the liquid desiccant at various points during operation of the HVAC system.

### SUMMARY

In some embodiments, a system to measure density of a liquid includes a measuring column having an inlet and an outlet, where the inlet is a distance below the outlet. In addition, the outlet is adapted such that liquid exits the outlet to low pressure. The system also includes a pressure sensor located proximate the inlet. Further, the system includes a processor adapted for receiving a reading from the pressure sensor and calculating a density of liquid flowing through the system using the reading.

In some embodiments, a method of determining a density of a liquid includes flowing a fluid through a measuring column having an inlet and an outlet, where the inlet is a distance below the outlet. In addition, the outlet is adapted such that the liquid exits the outlet to low pressure. The method also includes detecting a pressure on the fluid at a location proximate the inlet. Further, the method includes calculating a fluid density based on at least the detected pressure and the distance.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates a liquid concentration measurement flow system, in accordance with one embodiment;

FIG. 2 illustrates further details of the liquid concentration measurement flow system of FIG. 1, in accordance with one embodiment;

FIG. 3A illustrates portions of a measuring column, in accordance with one embodiment;

FIG. 3B illustrates portions of a measuring column, in accordance with one embodiment;

FIG. 4 illustrates further details of the concentration column of FIG. 3A, in accordance with one embodiment

FIG. 5 illustrates portions of a measuring column, in accordance with one embodiment;

FIG. 6 illustrates further details of the measuring column of FIG. 5, in accordance with one embodiment;

FIG. 7 illustrates portions of a measuring column, in accordance with one embodiment;

FIG. 8 illustrates portions of a measuring column, in accordance with one embodiment;

FIG. 9 illustrates portions of a measuring column, in accordance with one embodiment;

FIG. 10 illustrates portions of a measuring column, in accordance with one embodiment;

FIG. 11 is a flowchart for detecting liquid desiccant concentration, in accordance with one embodiment;

FIG. 12 is a flowchart for detecting liquid desiccant concentration, in accordance with one embodiment;

FIG. 13 is a flowchart for detecting liquid desiccant concentration, in accordance with one embodiment; and

FIG. 14 illustrates a liquid concentration measurement flow system, in accordance with one embodiment.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heating ventilation and air conditioning (HVAC) systems and, more particularly, to HVAC systems that use a conditioning fluid, such as liquid desiccant, to dehumidify and transfer heat from a fluid, such as air. The mass fraction of solute within a liquid desiccant (which can be referred to as a “concentration” of solute within the liquid desiccant) is an important parameter to know during the operation of an HVAC unit. For instance, the concentration of the solute within a liquid desiccant can affect the efficiency of desiccant regeneration, as well as the rate of moisture removal. The concentration of the solute can also affect crystallization of the liquid desiccant, which ideally is to be avoided within these HVAC systems.

The concentration measurement system disclosed herein may include a vertical columnar tube within the flow path of the desiccant. The vertical columnar tube may be configured such that it has the same liquid height, or nearly the same liquid height, regardless of the flow rate of liquid desiccant (even when not flowing). The vertical columnar tube may include a pressure sensor near the bottom portion. The pressure sensor may indicate a pressure of the liquid desiccant at the level within the tube that the pressure sensor is located. Based on the detected pressure and the height of the vertical columnar tube, a fluid density of the liquid desiccant can be determined. In some examples, a temperature sensor (e.g., a liquid temperature sensor) detects a temperature of the liquid desiccant. Based on the fluid density and temperature of the liquid desiccant, a concentration of the liquid desiccant can be computed.

The concentration of the liquid desiccant may have a strong correlation to its equilibrium humidity. As such, in some examples, the liquid desiccant system includes an air temperature and relative humidity (TRH) sensor that measures the relative humidity of the air above the liquid desiccant. The TRH sensor is strategically placed so as to measure a humidity value indicative of the liquid desiccant's equilibrium value. Based on the measured relative humidity of the air, the concentration of the liquid desiccant can be computed.

While the description provided herein discusses how the system measures the concentration of a solute (e.g., ionic species, such as a salt) species within a liquid desiccant, it will be understood that the concepts, systems, and techniques described herein can be used with other liquids containing any solute where the density of the fluid is related to the concentration of the solute.

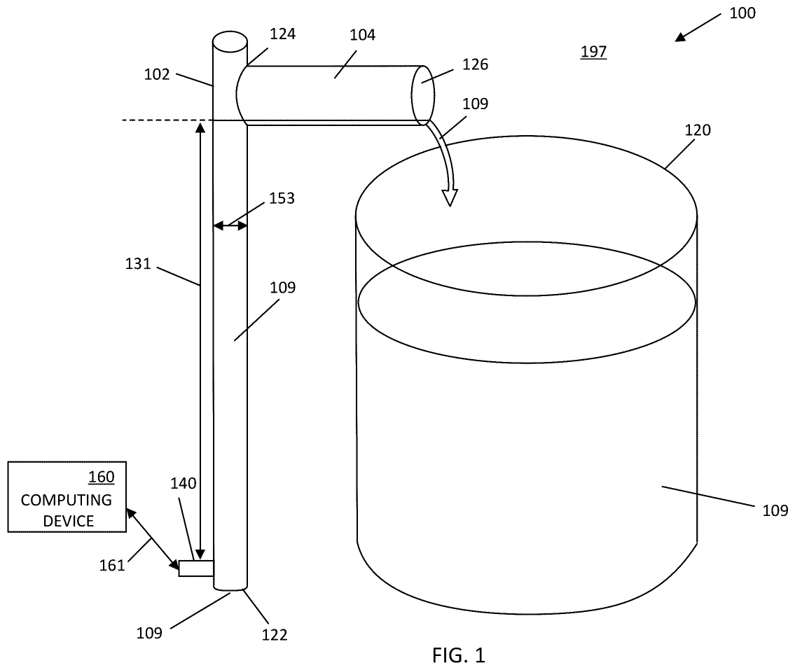

Referring now to the drawings, FIG. 1 illustrates a liquid concentration measurement flow system 100 that includes a measuring column 102, an exit tube 104, a liquid desiccant tank 120, a pressure sensor 140 in fluid communication with liquid in the measuring column, and a computing device 160. As illustrated, a liquid desiccant 109 may be pumped through an inlet 122 of the measuring column 102. The measuring column 102 may be generally vertical, i.e., 90 degrees to the ground. In some examples, the measuring column 102 may be less than or equal to 10 degrees from vertical. In some examples, the measuring column 102 may be less than or equal to 7.5 degrees from vertical. In some examples, the measuring column 102 may be less than or equal to 5 degrees from vertical. In some examples, the measuring column 102 may be less than or equal to 2.5 degrees from vertical. In some examples, the measuring column 102 may be less than or equal to 1 degree from vertical.

The liquid desiccant 109 flows up through the measuring column 102 and out an outlet 124. The outlet 124 may be a predetermined distance 131 above the pressure sensor 140. For example, the distance 131 may be at least 5 times a diameter 153 of the measuring column 102. In some examples, the distance 131 may be at least at least 10, 12.5, 15, 17.5, or 20 times the diameter 153. The liquid desiccant 109 proceeds into the exit tube 104, and flows through the exit tube 104 and out an exit tube outlet 126 to an ambient area 197 with low pressure (e.g., lower pressure than within measuring column 102). For instance, ambient area 197 may have a pressure less than 1.15 atmosphere (atm), less than 1.1 atm, less than 1.05 atm, or less than 1.02 atm.

Further, the liquid desiccant 109 exits out the exit tube outlet 126, and flows into a liquid desiccant tank 120 or other portion of the liquid desiccant flow path within the system. Of particular interest, the liquid desiccant 109 exiting the measuring column is exiting without back-pressure. Thus, the pressure measured by the pressure sensor 140 is produced exclusively or almost exclusively by the weight of fluid in the measuring column 102. This enables for accurate measurement of the density of the fluid in the measuring column 102.

In some examples, the measuring column 102 and the exit tube 104 may each be in the form of a circular tube. For instance, they each may have a fixed or uniform corresponding inside cross-sectional area throughout. Moreover, the bottom of the exit tube 104 may form an angle 171 with the measuring column 102. In some examples, the angle 171 may be near 90 degrees. In some examples, the angle 171 may be less than 90 degrees. In some examples, the measuring column 102 and/or the exit tube 104 are pipes. As described herein, the inside cross-sectional area of the exit tube 104 may be greater than the inside cross-sectional area of the measuring column 102. For instance, an inside diameter of the exit tube 104 may be greater than an inside diameter of the measuring column 102. In addition, they each may be manufactured from any suitable rigid material, such as metal, glass, plastic, and ceramic materials.

Because the overflow path provided by the exit tube 104 is sufficiently open, the overflow path allows for a significant exit flow rate for relatively small increases in liquid desiccant 109 level height above its bottom. In some instances, when the angle 171 is less than 90 degrees (e.g., in the range of 75 to 89 degrees), gravity allows the liquid desiccant 109 to flow freely into the liquid desiccant tank 120. The height 131 of the liquid desiccant 109 can be estimated as the distance from the pressure sensor 140 to the bottom of the exit tube 140, or to a distance above the bottom of the exit tube 104. Based on the height 131, the density of the liquid desiccant 109 can be computed.

For instance, the formula for hydrostatic pressure is P=ρ·g·h, where P is the pressure, ρ is the fluid density, g is the acceleration of gravity, and h is the height of a fluid column, e.g., distance 131. Based on this hydrostatic pressure formula, the fluid density can be determined according to ρ=P/(g·h). Thus, to determine the fluid density, the pressure P and the height h need to be known (the acceleration of gravity g is known).

Referring back to FIG. 1, to determine the density of the liquid desiccant 109, the liquid concentration measurement flow system 100 may include a pressure sensor 140 that detects a pressure of the liquid desiccant 109 within the measuring column 102. For instance, and as further described below, the pressure sensor 140 may be located near the inlet 122 of the measuring column 102. Based on a pressure reading from the pressure sensor 140 and the known height 131, a density and/or concentration of the liquid desiccant 109 can be computed.

For example, computing device 160 may be communicatively coupled to the pressure sensor 140 over one or more wired or wireless communication channels 161 (e.g., a WiFi® or BlueTooth® connection). The computing device 160 may include one or more processors that execute instructions to carry out operations, such as any of the operations described herein. The computing device 160 may receive a reading characterizing a detected pressure from the pressure sensor 140 (e.g., periodically, based on a schedule, etc.). Based on the reading, the computing device 160 may compute the density of the liquid desiccant 109. For example, the computing device 160 may perform operations to divide the reading by a predetermined height, which in this example may correspond to the height 131, and to divide the result by the acceleration of gravity (i.e., acceleration of gravity g), to compute a density value characterizing the density of the liquid desiccant 109. In some examples, the computing device 160 may compute a concentration value characterizing a concentration of the liquid desiccant 109 based on the density value. For example, the computing device 160 may apply any suitable density to concentration formula to the density value to compute the concentration value, such as any of the known formulas (e.g., algorithms) recognized by persons of ordinary skill in the art.

Further, in some examples, the computing device 160 determines a parameter for operating a liquid desiccant regenerator based on the computed concentration value and/or density value. For example, the parameter may relate to or inform whether a regenerator is on or off, a value for a liquid desiccant flow rate through a conditioner or a regenerator, a value for an air flow rate through a conditioner or a regenerator, or a value for an operating temperature of a conditioner or a regenerator.

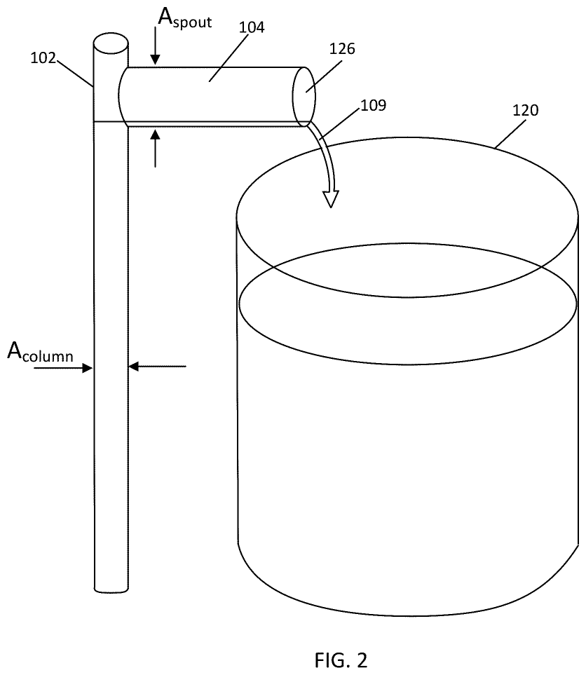

FIG. 2 identifies a cross-sectional area A_{column} of the measuring column 102 and a cross-sectional area Aₛₚₒᵤₜ of the exit tube 104. As such, the measuring column 102 is manufactured to have a cross-sectional area A_{column} that is based on expected liquid desiccant 109 flow rates so as to prevent the negative impacts of high velocity liquid desiccant 109 flow. For instance, if A_{column} is too large, it may take too long for changes in concentration to be detected. Alternately, if A_{column} is too small, the flow rate may increase pressure that is not a result of changes in density of the liquid in the measuring column 102. The pressure sensor 140, being positioned near the inlet 122 of the measuring column 102, may detect an average density of the liquid desiccant 109 within the measuring column 102. In some embodiments, the measuring column 102 and the exit tube 104 are manufactured such as to have a cross-sectional area ratio of Aₛₚₒᵤₜ to A_{column} of 1, or 2, or 5, or 10, or larger.

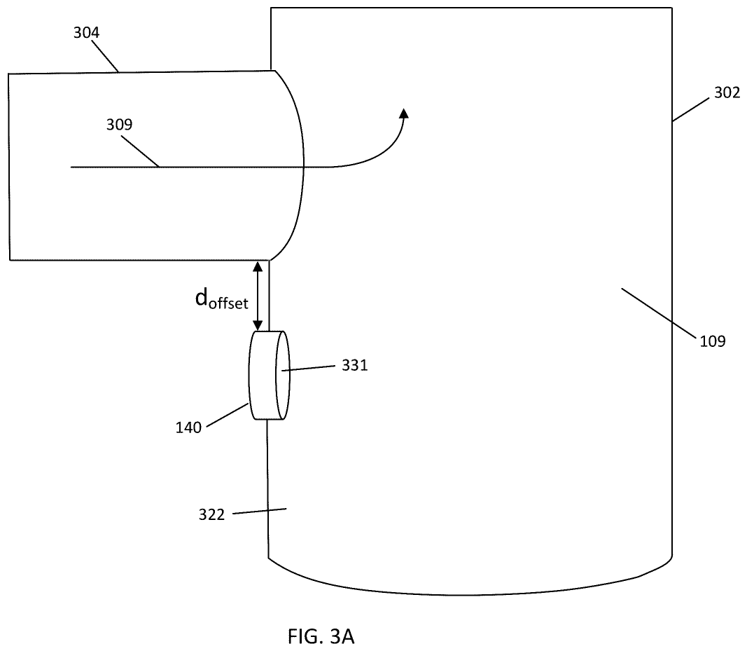

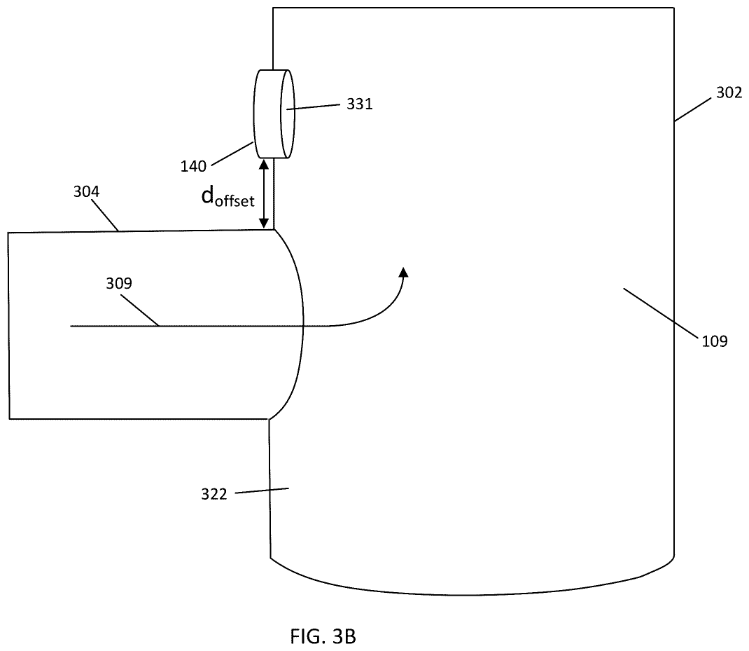

FIG. 3A illustrates a measuring column 302 with an entrance tube 304 that provides the liquid desiccant 109 to an interior of the measuring column 302. In this example, a pressure sensor 140 is placed below the entrance tube 304 by an amount identified as d_{offset}. By placing the pressure sensor 140 below the entrance tube 304 by at least the d_{offset} amount, the pressure sensor 140 may avoid affects from any eddies formed from the flow 309 of liquid desiccant 109 entering the measuring column 302 and any direct impacts caused by the flow of liquid desiccant 109 into the measuring column 302.

Because liquid desiccant 109 in a bottom portion 322 of the measuring column 302 that is below the entrance tube 304 may be stagnant, its concentration may be less likely to change as the concentration of the liquid desiccant 109 coming into the measuring column 302 through the entrance tube 304 changes. For instance, a portion of the liquid desiccant 109 within the measuring column 302 will have a density that is not representative of the density of the liquid desiccant 109 proceeding upward through the measuring column 302. To offset these potential causes of error, in some examples, the pressure sensor 140 is positioned at a maximum of a d_{offset} amount to keep any potential pressure sensor 140 errors below a minimum threshold. The d_{offset} amount may be determined empirically for a given measuring column 302 configuration, for example. In some examples, the d_{offset} amount is less than 3 inches, less than 2 inches, or less than 1 inch. The density can then be measured based on the height 131 starting from the sensor 140 to the exit tube 104.

As illustrated in FIG. 3B, in some examples, the pressure sensor 140 is placed above the entrance tube 304 by a d_{offset} amount. In this example, the pressure sensor 140 is located in a location where the liquid desiccant 109 is not stagnant, as the liquid desiccant 109 flows up through the measuring column 302. The density can then be measured based on the height of the column 131 starting from the sensor 140 to the exit tube 104.

Because the flow of the liquid desiccant 109 is parallel, or nearly parallel, to the surface 331 of the pressure sensor 140, any affects from the flow of liquid desiccant 109 into the measuring column 302 may be minimal. Moreover, because the pressure sensor 140 is located within the measuring column 302 and above the entrance tube 304, the pressure readings by the pressure sensor 140 are based on non-stagnant liquid desiccant 109 flow. Because the pressure sensor 140 is located higher up along the measuring column 302 compared to when placed under the entrance tube 304, any variations in liquid desiccant height (as measured from the pressure sensor 140 upward to an upper surface of the liquid desiccant 109 entering the exit tube 104) may be a larger percentage of the nominal liquid desiccant 109 height within the measuring column 302.

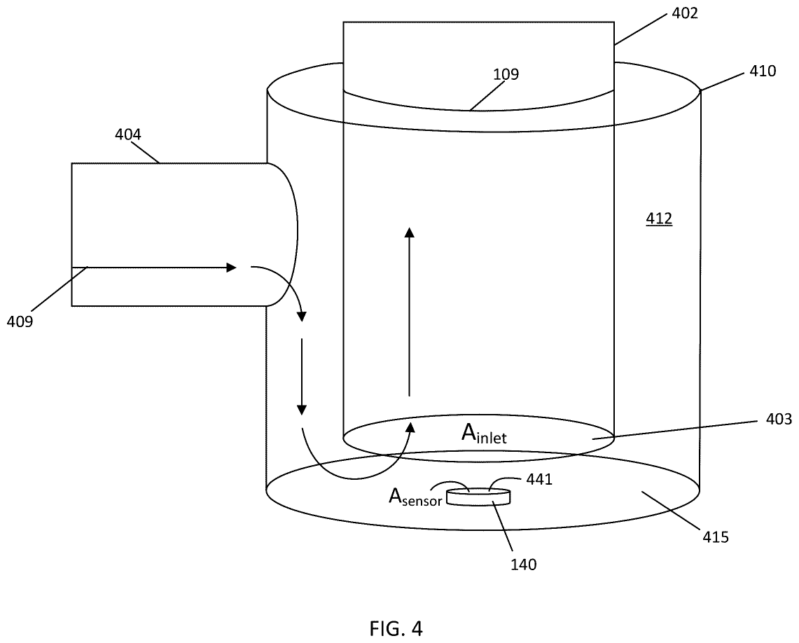

FIG. 4 illustrates a measuring column 402 that extends into a base cap 410 that forms a concentric annulus region 412 with the measuring column 402. For instance, the base cap 410 encircles a lower end of the measuring column 402. A flow 409 of the liquid desiccant 109 proceeds from an entrance tube 404 into the concentric annulus region 412, and continues downward through the concentric annulus region 412 before proceeding up through inlet 403 into the measuring column 402. In other words, the liquid desiccant 109 is fed to the inlet 403 from the base cap 410 (e.g., feed conduit) encircling the lower end of the measuring column 402.

A pressure sensor 140 can be positioned on a base surface 415 of the base cap 410. Although the flow 409 of liquid desiccant 109, when proceeding downward towards the base surface 415 of the base cap 410, may impart pressure on a surface 441 of the pressure sensor 140, the effects of this pressure can be reduced (e.g., kept to a minimum) by reducing a ratio of the cross-sectional area Aₛₑₙₛₒᵣ of the pressure sensor 140 to the cross-sectional area Aᵢₙₗₑₜ of the inlet 403. For instance, the measuring column 402 and base cap 410 may be manufactured such as to have a ratio of Aₛₑₙₛₒᵣ to Aᵢₙₗₑₜ below a maximum threshold (i.e., Aₛₑₙₛₒᵣ/Aᵢₙₗₑₜ<Max Value). This ratio may be empirically determined, for example. In some examples, a ratio of Aᵢₙₗₑₜ to Aₛₑₙₛₒᵣ is at least 4. In some examples, the ratio is at least 8. In some examples, the ratio is at least 16. In some examples, the ratio is at least 32. In some examples, the ratio is at least 64. In some examples, the ratio is at least 128. In some examples, the ratio is at least 256.

In some examples, the pressure sensor 140 is coupled to a base surface 415 of the base cap 410. In some examples, at least a portion of the pressure sensor 140 is within an area of the inlet 403, i.e., Aᵢₙₗₑₜ. In some examples, at least a portion of the pressure sensor 140 is outside the area of the inlet 403.

The arrangement of FIG. 4 is provided to minimize flow effects on the pressure detected by the sensor 140. The momentum of the liquid exiting the entrance tube 404 is redirected around the outer surface of the measuring column 402. The liquid then flows around the lower edges of the measuring column 402. By reducing the area of the sensor 140, the impact of the liquid flow on the pressure measured by the sensor 140 is minimized.

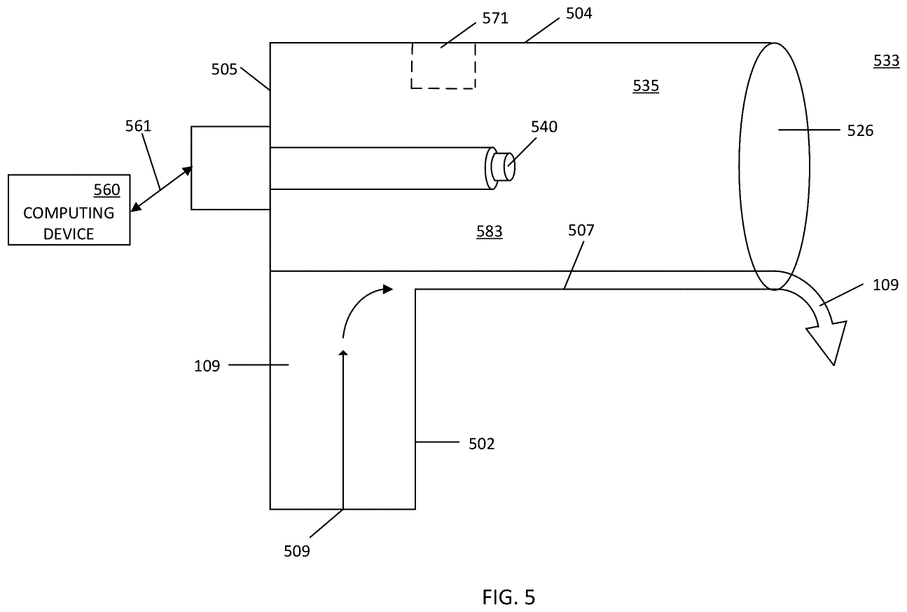

As described herein, liquid desiccant concentration may be determined, refined, or confirmed using equilibrium humidity. For example, FIG. 5 illustrates a flow 509 of liquid desiccant 109 that proceeds upwards through a measuring column 502 and into a cavity 583 of an exit tube 504, before proceeding out through exit tube outlet 526 (e.g., to flow into a liquid path). In this example, a cross-sectional area of the exit tube 504 is larger than a cross-sectional area of the measuring column 502. For instance, the cross-sectional area of the exit tube 504 may be 1, 1.5, 2, or 3 times greater than the cross-sectional area of the measuring column 502. In other examples, the cross-sectional area of the exit tube 504 is smaller than the cross-sectional area of the measuring column 502.

Further, a humidity sensor 540 (e.g., a relative humidity sensor) is positioned within the exit tube 504, and is configured to detect a humidity within the exit tube 504. The humidity sensor 540 may, for example, be attached to a wall 505 of the exit tube 504, and may be positioned horizontally above the flow (e.g., horizontal flow) of liquid desiccant 109. Further, the humidity sensor 540 may be communicatively coupled to a computing device 560 over one or more wired or wireless communication channels 561 (e.g., a WiFi® or BlueTooth® connection). The computing device 560 may receive humidity data from the humidity sensor 540. The humidity data may characterize a detected humidity level. The computing device 560 may compute a concentration value characterizing a concentration of the liquid desiccant 109 based on the humidity data.

For example, the computing device 560 may execute any known algorithm to compute the concentration value based on the humidity data. In some examples, the computing device 560 may determine the concentration value based on a stored table that includes ranges of humidity levels and corresponding concentration values. For instance, the computing device 560 may compare the humidity data to a range of humidity levels stored in memory, determine that the humidity data falls within the range, and retrieve the concentration value corresponding to the range from the memory. Further, in some examples, the computing device 560 may compute a density value characterizing a density of the liquid desiccant 109 based on the concentration value, as described herein.

In some examples, the computing device 560 determines a parameter for operating a liquid desiccant regenerator based on the computed concentration value and/or density value. For example, the parameter may characterize whether the regenerator is on or off, a liquid desiccant flow rate, an air flow rate, or an operating temperature.

In some examples, the humidity sensor 540 is positioned within the cavity 583 of the exit tube 504. The cavity 583 may include a relatively small volume of air 535 (e.g., an isolated pocket of air of the measuring column 502), thereby reducing the time it takes the humidity sensor 540 to reach equilibrium humidity. In addition, the humidity sensor 540 may be exposed to a relatively large surface area of the liquid desiccant 109, thereby increasing the rate of moisture transfer and the rate of approach to humidity equilibrium. In some examples, the surface of the liquid desiccant 109 exposed to the volume of air 535 within the cavity 583 is flowing. As such, the flowing liquid desiccant 109 is in contact with the volume of air that the humidity sensor 540 is measuring.

In some examples, the volume of air within exit tube 504 is in contact with (e.g., has access to) other volumes of air, such as ambient air 533, whose humidity does not represent the desiccant's equilibrium. Further, in some examples, the humidity sensor 540 is positioned a minimum distance above a bottom surface 507 of the exit tube 504, thereby ensuring that the humidity sensor 540 is not at risk of coming in contact with (e.g., getting wet by) the liquid desiccant 109.

In some examples, a temperature sensor 571 is positioned within the exit tube 504. The computing device 560 may receive temperature readings from the temperature sensor 571 and humidity readings from the humidity sensor 540. In some embodiments, the humidity sensor 540 can be a relative humidity sensor, which measures both temperature and humidity. In such embodiments, the temperature sensor 571 may be unnecessary. The computing device 560 may calculate a density of the liquid desiccant 109 using the humidity readings from the humidity sensor 540 and the temperature readings from the temperature sensor 571.

In some examples, the computing device 560 may determine if the first density is within a predetermined range. If the first density is not within the predetermined range, the computing device 560 may generate and transmit an error signal indicating the discrepancy (e.g., causing a display to display a warning message).

In some examples, the cross-sectional area of an exit tube is smaller than the cross-sectional area of a measuring column, thereby providing a greater tendency for the exit tube to fill with liquid desiccant. More importantly, this arrangement can be used to create an isolated and sealed section to measure humidity, temperature, or both of the area above the liquid desiccant 109.

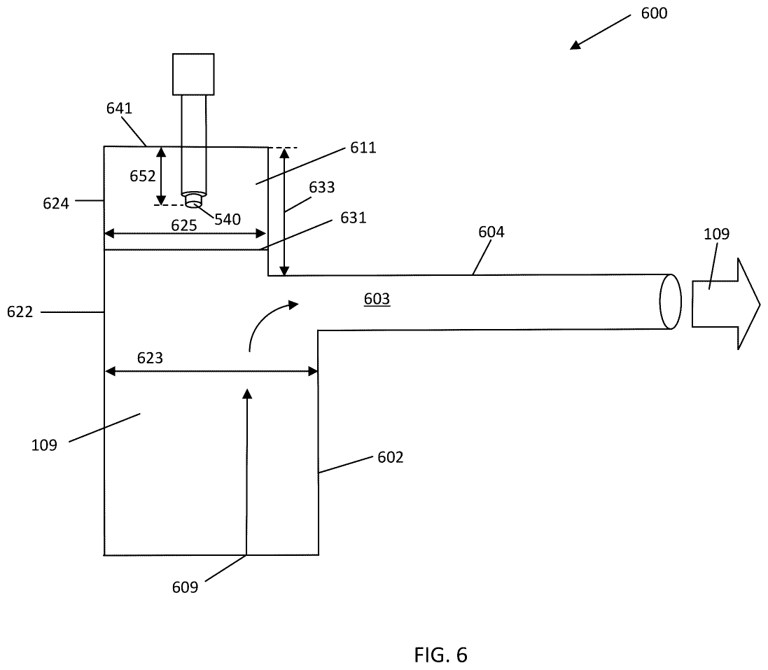

For example, FIG. 6 illustrates a liquid concentration measurement flow system 600 that can provide a flow 609 of liquid desiccant 109 that proceeds upwards through a measuring column 602 and into a cavity 603 of an exit tube 604. In this example, a cross-sectional area of the exit tube 604 is smaller than a cross-sectional area of the measuring column 602. For instance, the cross-sectional area of the exit tube 604 be 1.5, 2, or 3 times smaller than the cross-sectional area of the measuring column 602.

In this example, the measuring column 602 includes a bottom portion 622 and a top portion 624. In some, but not all embodiments, the bottom portion has a diameter 623 that is greater than a diameter 625 of the top portion 624. The diameter 625 may be, for example, between 15% and 45% (e.g., 25%) less than the bottom diameter 623. In addition, the top portion 624 includes sealed air section 611 designed so that the liquid desiccant 109 does not contact the humidity sensor 540 directly. For instance, assuming no leaks, the sealed air section 611 would tend to pressurize when the flow rate of liquid desiccant 109 increases, which would force the liquid desiccant 109 out of the exit tube 604 at a faster rate.

In some examples, a height 633 of the top portion 624 is in the range of 5% to 50% of the height of the measuring column 602. Further, a humidity sensor 640 is positioned within the sealed air section 611 to detect humidity. For example, the humidity sensor 640 may proceed through a top surface 641 of the top portion 624. In addition, the humidity sensor 640 may proceed into the measuring column 602 up to a maximum offset distance 652. A computing device, such as computing device 560, may receive humidity data from the humidity sensor 640.

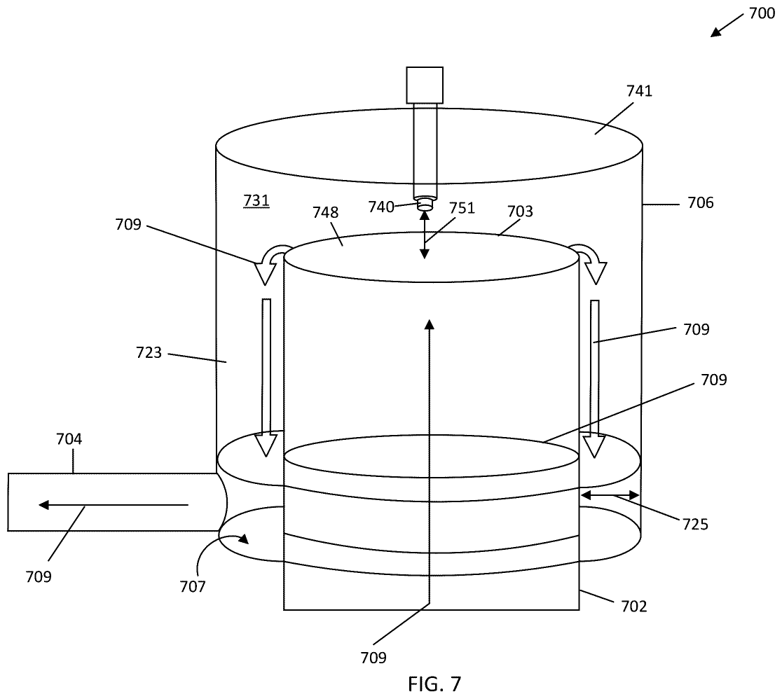

FIG. 7 illustrates an example of a liquid concentration measurement flow system 700 that includes a measuring column 702 and an overflow housing 706. The overflow housing 706 includes a liquid collection portion with a floor 707 that is below the upper end of the measuring column 702 and an upper surface above the upper end of the measuring column 702. In some examples, the floor 707 attaches (e.g., and is sealed to) an outer wall of the measuring column 702.

A flow 709 of liquid desiccant 109 flows up the measuring column 702, overflows over its top edge 703, and falls down towards an annulus 723 formed by an interior wall of the overflow housing 706 and an outer wall of the measuring column 702. For example, the difference between the radius of the overflow housing 706 and the radius of the measuring column 702 determines a width 725 of the annulus 723. Moreover, the overflow housing 706 and measuring column 702 provide a sealed air pocket housing 731 that prevents, for example, contamination from ambient air. Air within the air pocket housing 731 is in fluid communication liquid desiccant 109 exiting through an outlet 748 of the measuring column 702. The outlet 748 may be an upper end of the measuring column 702. The flow 709 of the liquid desiccant 109, after falling into the annulus 723, may then exit out an exit tube 704.

Further, in this example, a humidity sensor 740 is positioned within the sealed air pocket housing 731 to detect humidity. For example, the humidity sensor 740 may proceed through a top surface 741 of the overflow housing 706. In addition, the humidity sensor 740 may be distanced from the outlet 748 of the measuring column 702 by at least a minimum offset distance 751. A computing device, such as computing device 560, may receive humidity data from the humidity sensor 740.

In some examples, any of the liquid concentration measurement flow systems 600, 700 may, additionally or alternatively, include a pressure sensor, such as pressure sensor 140. Likewise, any of the liquid concentration measurement flow systems described with respect to any of FIGS. 1, 2, 3, and 4 may, additionally or alternatively, include a humidity sensor, such as any of humidity sensors 540, 640, 740. For example, a bottom portion of a measuring column can be dedicated to accommodating a pressure sensor (e.g., as illustrated by measuring column 402 in FIG. 4) and the top portion can be dedicated to accommodating a humidity sensor (e.g., as illustrated by measuring column 702 in FIG. 7).

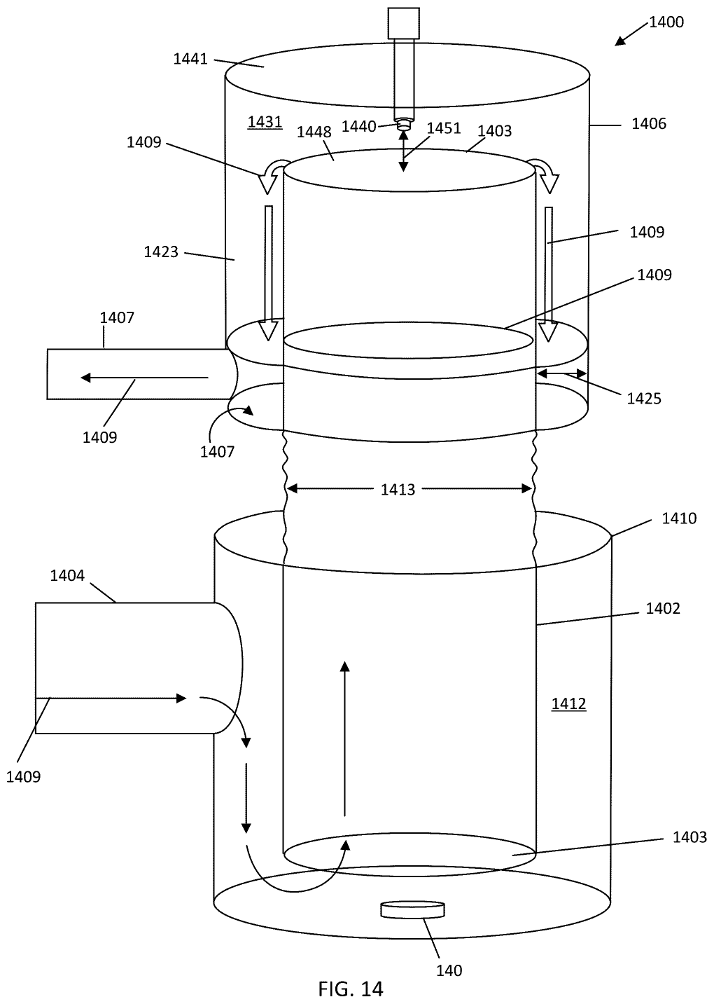

For instance, FIG. 14 illustrates a liquid concentration measurement flow system 1400 that includes a measuring column 1402 that extends into a base cap 1410 at one end and an overflow housing 1406 at an opposite end. The measuring column 1402 may be of any suitable height, and the distance between the base cap 1410 and the overflow housing 1406 is not necessarily shown to scale, as indicated by squiggly lines 1413. The base cap 1410 forms a concentric annulus region 1412 with the measuring column 1402. For instance, the base cap 1410 encircles a lower end of the measuring column 1402. A flow 1409 of the liquid desiccant 109 proceeds from an entrance tube 1404 into the concentric annulus region 1412, and continues downward through the concentric annulus region 1412 before proceeding up through inlet 1403 into the measuring column 1402. In other words, the liquid desiccant 109 is fed to the inlet 1403 from the base cap 1410 (e.g., feed conduit) encircling the lower end of the measuring column 1402. As illustrated, a pressure sensor 140 can be positioned on a base surface 1415 of the base cap 1410.

Further, the overflow housing 1406 includes a liquid collection portion with a floor 1407 that is below the upper end of the measuring column 1402 and an upper surface above the upper end of the measuring column 1402. In some examples, the floor 1407 attaches (e.g., and is sealed to) an outer wall of the measuring column 1402. The flow 1409 of liquid desiccant 109 continues to flow up the measuring column 1402, overflows over its top edge 1403, and falls down towards an annulus 1423 formed by an interior wall of the overflow housing 1406 and an outer wall of the measuring column 1402. Moreover, the overflow housing 1406 and measuring column 1402 provide a sealed air pocket housing 1431 that prevents, for example, contamination from ambient air. Air within the air pocket housing 1431 is in fluid communication liquid desiccant 1409 exiting through an outlet 1448 of the measuring column 1402. The outlet 1448 may be an upper end of the measuring column 1402. The flow 1409 of the liquid desiccant 109, after falling into the annulus 1423, may then exit out an exit tube 1407.

Further, a humidity sensor 1440 is positioned within the sealed air pocket housing 1431 to detect humidity. For example, the humidity sensor 1440 may proceed through a top surface 1441 of the overflow housing 1406. In addition, the humidity sensor 1440 may be distanced from the outlet 1448 of the measuring column 1402 by at least a minimum offset distance 1451. A computing device, such as computing device 560, may receive humidity data from the humidity sensor 1440 and pressure data from the pressure sensor 140.

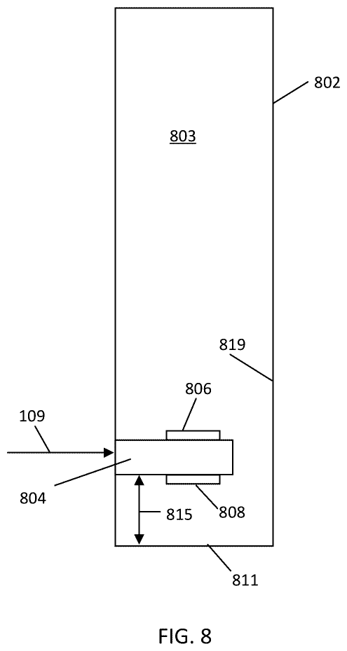

FIG. 8 illustrates a measuring column 802 that includes a projection 804 through which a liquid desiccant 109 passes into, and proceeds to enter into a cavity 803 of the measuring column 802 through an inlet 806 positioned on an upper side of the projection 804. A sensor 808, such as a pressure sensor or temperature sensor, is positioned on the bottom side of the projection 804. As such, the inlet 806 and the sensor 808 are within an interior of the measuring column 802. The projection 804 may be positioned a predetermined distance 815 from a bottom surface 811 of the measuring column 802.

In some examples, the projection 804 is a tube, and the inlet 806 is on a top of the projection 804. In some examples, the inlet 806 is on a bottom of the projection 804. In some examples, the sensor 808 is on a face of the projection 804. In some examples, the sensor 808 is adjacent the inlet 806. In some examples, the sensor 808 is on a side of the projection 804 and opposite the inlet 806. In some examples, the sensor 808 is on a wall 819 of the measuring column 802.

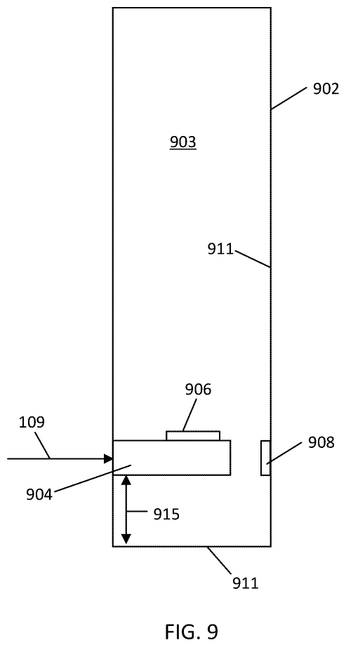

FIG. 9 illustrates a measuring column 902 that includes a projection 904 through which a liquid desiccant 109 passes into, and proceeds to enter into a cavity 903 of the measuring column 902 through an inlet 906 positioned on an upper side of the projection 904. A sensor 908, such as a pressure sensor, is positioned on an interior wall 911 of the measuring column 902. The projection 904 may be positioned a predetermined distance 915 from a bottom surface 911 of the measuring column 902.

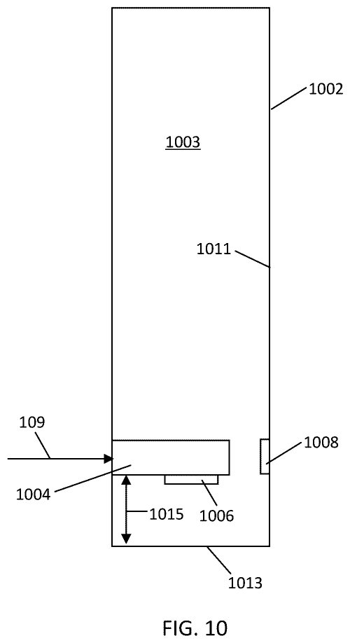

FIG. 10 illustrates a measuring column 1002 that includes a projection 1004 through which a liquid desiccant 109 passes into, and proceeds to enter into a cavity 1003 of the measuring column 1002 through an inlet 1006 positioned on a lower side of the projection 1004. A sensor 1008, such as a pressure sensor, is positioned on an interior wall 1011 of the measuring column 1002. The projection 1004 may be positioned a predetermined distance 1015 from a bottom surface 1013 of the measuring column 1002.

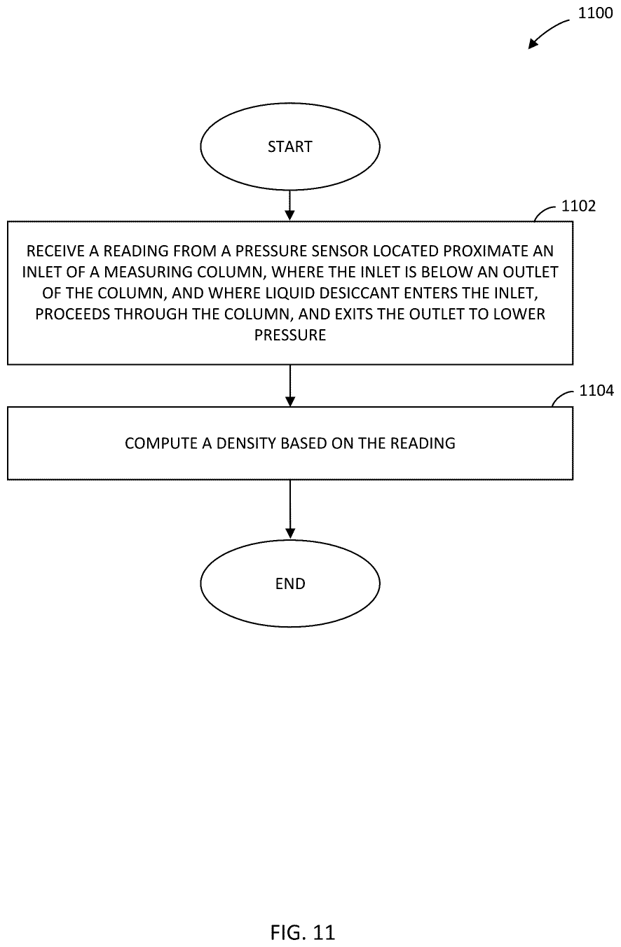

FIG. 11 illustrates a flowchart of a method 1100 of detecting liquid desiccant concentration desiccant. The method may be carried out by one or more processors, such as one or more processors of computing device 160. Beginning at block 1102, a reading is received from a pressure sensor located proximate an inlet of a measuring column, where the inlet is below an outlet of the column, and where liquid desiccant enters the inlet, proceeds through the column, and exits the outlet to lower pressure. At block 1104, a density is computed based on the reading.

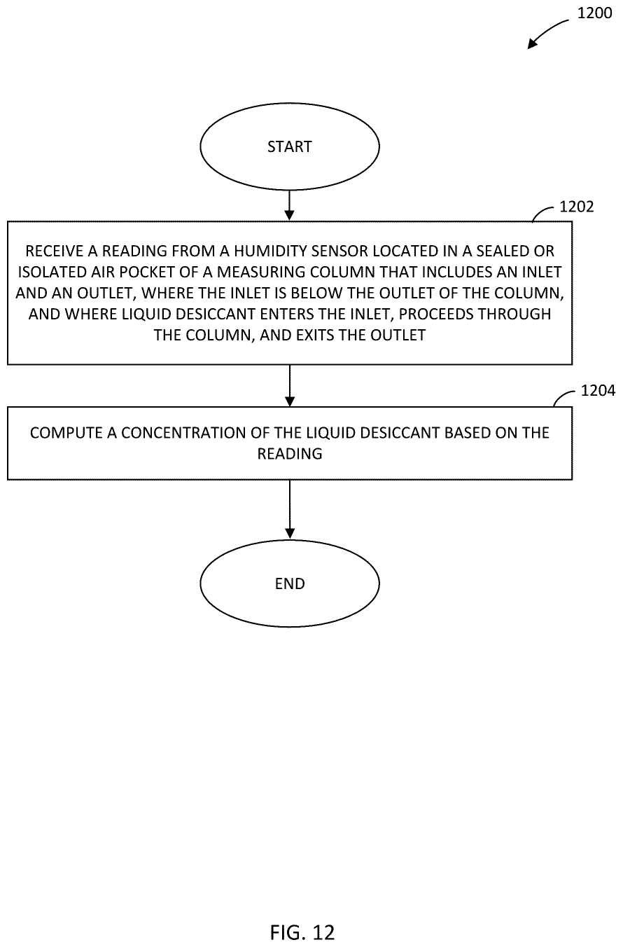

FIG. 12 illustrates a flowchart of a method 1200 of detecting liquid desiccant concentration desiccant. The method may be carried out by one or more processors, such as one or more processors of computing device 160. Beginning at block 1202, a reading is received from a humidity sensor located in a sealed or isolated air pocket of a measuring column that includes an inlet and an outlet, where the inlet is below the outlet of the column, and where liquid desiccant enters the inlet, proceeds through the column, and exits the outlet. At block 1204, a concentration of the liquid desiccant is computed based on the reading.

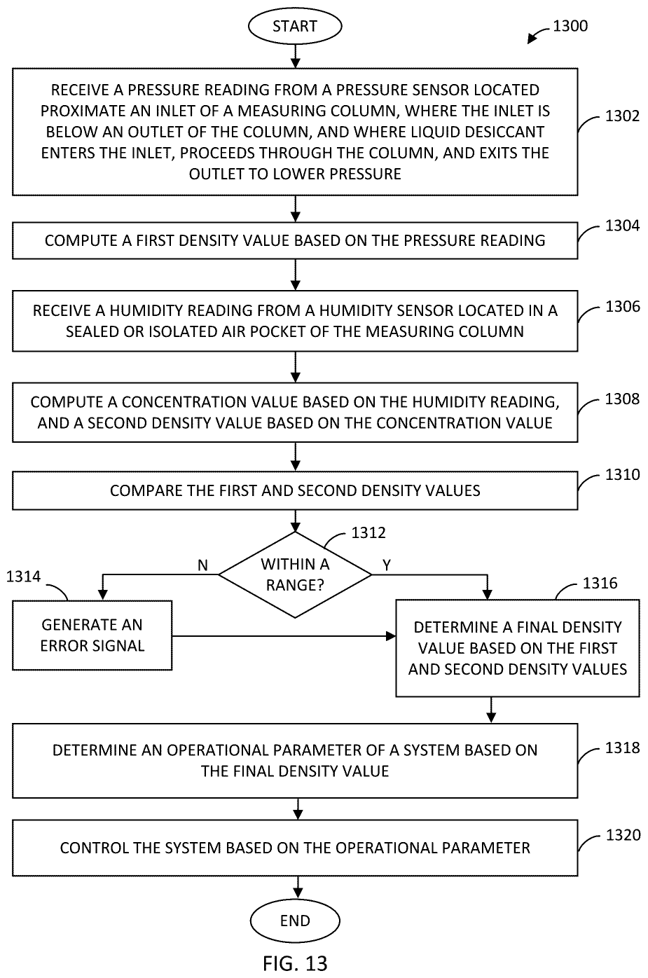

FIG. 13 illustrates a flowchart of a method 1300 of detecting liquid desiccant concentration desiccant. The method may be carried out by one or more processors, such as one or more processors of computing device 160. Beginning at block 1302, a pressure reading is received from a pressure sensor located proximate an inlet of a measuring column, where the inlet is below an outlet of the column, and where liquid desiccant enters the inlet, proceeds through the column, and exits the outlet to lower pressure. At block 1304, a first density value is computed based on the pressure reading. Further, at block 1306, a humidity reading is received from a humidity sensory located in a sealed or isolated air pocket of the measuring column. At block 1308, a concentration value is computed based on the humidity reading, and a second density value is computed based on the concentration value. For example, the second density value may be computed using any known algorithm that converts concentration values to density values.

Proceeding to block 1310, the first density value and second density value are compared. At block 1312, if the first density value and second density value are within a range (e.g., 10% of each other, a predetermined density amount, etc.), the method proceeds to block 1316. Otherwise, if the first density value and second density value are not within the range, the method proceeds to block 1314, where an error signal is generated. For example, the error signal may cause a message (e.g., email, text, etc.) to be sent indicating an error that the density values were not within the range. As another example, the error signal may cause a user interface to display an indication of the error. In yet other examples, the error signal may be used to indicate an uncertainty for the computed density values. For example, the error signal may indicate that the first density value and second density value, while still being used to compute a final density value (see block 1316, below), differ from each other by greater than a range of uncertainty (e.g., a predetermined range of uncertainty). The method then proceeds to block 1316.

At block 1316, a final density value is determined based on the first and second density values. For example, the final density value may be an average of the first and second density values. In some examples, a weight is applied to one or more of the first and second density values, and the final density value is computed based on the one or more weighted first and second density values. For example, a first weight may be applied to any of the first and second density values when they are within range (e.g., an expected range), and a second weight may be applied to any of the first and second density values when they are outside the range. The final density value may then be computed based on an average of the first and second density values if and as weighted.

The method then proceeds to block 1318 where an operational parameter of a system, such as a liquid desiccant regenerator or conditioner, is determined based on the final density value. For example, the operational parameter may determine whether a liquid desiccant regenerator or conditioner is on or off, a liquid desiccant flow rate through the liquid desiccant regenerator, an air flow rate through the liquid desiccant regenerator, or an operating temperature of the liquid desiccant regenerator. Further, and at block 1320, the system is controlled based on the operational parameter (e.g., the system is turned on or off, the liquid desiccant flow rate is adjusted, the air flow rate is adjusted, or the system is adjusted to the operating temperature).

In some examples, a system to measure density of a liquid includes a measuring column having an inlet and an outlet, where the inlet is a distance (h) below the outlet. The system also includes a pressure sensor located proximate the inlet, where the outlet is adapted such that liquid exits the outlet to low pressure. Further, the system includes a processor adapted for receiving a reading from the pressure sensor and calculating a density of liquid flowing through the system using the reading.

In some examples, the measuring column is ≤15 degrees from vertical. In some examples, the distance (h) is at least 5 times a diameter (d) of the measuring column. In some examples, the pressure sensor is located below the inlet. In some examples, the inlet is an opening in a wall of the measuring column.

In some examples, the inlet is within an interior of the measuring column. In some examples, the system includes a projection extending from a wall of the measuring column, wherein the projection comprises the inlet.

In some examples, the system includes a liquid temperature sensor adapted for measuring a temperature of liquid flowing through the system.

In some examples, the inlet is a lower end of the measuring column. In some examples, the liquid is fed to the inlet from a feed conduit encircling the lower end of the measuring column. In some examples, the feed conduit has a base surface below the lower end and the pressure sensor is below the lower end. In some examples, an area of the pressure sensor (Aₛₑₙₛₒᵣ) is less than a cross-sectional area of the measuring column (A_{column}). In some examples, the system includes a liquid temperature sensor adapted for measuring a temperature of liquid flowing through the system, wherein the liquid temperature sensor is coupled to the feed conduit.

In some examples, the system includes an air pocket housing in fluid communication with the liquid exiting the measuring column, and a humidity sensor adapted for measuring vapor pressure within the air pocket housing. In some examples, the system includes a temperature sensor adapted for measuring a temperature within the air pocket housing. In some examples, the air pocket housing is enclosed and isolated from an external atmosphere.

In some examples, the outlet is an upper end of the measuring column, and the liquid exiting the measuring column flows over upper edges of the measuring column. In some examples, the upper end is encircled by an overflow housing adapted to capture liquid exiting the measuring column. In some examples, the overflow housing includes a liquid collection portion below the upper end of the measuring column and an upper surface above the upper end. In some examples, the system includes a humidity sensor adapted for measuring a humidity of air within the overflow housing. In some examples, the system includes a temperature sensor adapted for measuring a temperature within the overflow housing.

In some examples, the outlet is an upper end of the measuring column, and the liquid exiting the measuring column flows over upper edges of the measuring column. In some examples, the upper end is encircled by an overflow housing adapted to capture the liquid exiting the measuring column.

In some examples, the system includes a spout in liquid communication with the outlet, wherein a cross-sectional area of the spout (Aₛₚₒᵤₜ) is larger than a cross-sectional area of the measuring column (A_{MC}).

In some examples, a method of determining a density of a liquid includes flowing a fluid through a measuring column having an inlet and an outlet, wherein the inlet is a distance (h) below the outlet. The method also includes detecting a pressure on the fluid at a location proximate the inlet, where the outlet is adapted such that the liquid exits the outlet to low pressure. Further, the method includes calculating a fluid density based on at least the detected pressure and the distance (h). In some examples, the fluid density is used to determine a parameter for operating a liquid desiccant regenerations.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A system to measure density of a liquid, comprising:
a measuring column having an inlet and an outlet, wherein the inlet is a distance (h) below the outlet;
a pressure sensor located proximate the inlet, wherein the outlet is adapted such that liquid exits the outlet to low pressure; and
a processor adapted for receiving a reading from the pressure sensor and calculating a density of liquid flowing through the system using the reading.

2. The system of claim 1, wherein the measuring column is ≤15 degrees from vertical.

3. The system of claim 1, wherein the distance (h) is at least 5 times a diameter (d) of the measuring column.

4. The system of claim 1, wherein the pressure sensor is located below the inlet.

5. The system of claim 1, wherein the inlet is an opening in a wall of the measuring column.

6. The system of claim 1, wherein the inlet is within an interior of the measuring column.

7. The system of claim 6, comprising a projection extending from a wall of the measuring column, wherein the projection comprises the inlet.

8. The system of claim 1, further comprising a liquid temperature sensor adapted for measuring a temperature of liquid flowing through the system.

9. The system of claim 1, wherein the inlet is a lower end of the measuring column.

10. The system of claim 9, wherein the liquid is fed to the inlet from a feed conduit encircling the lower end of the measuring column.

11. The system of claim 10, wherein the feed conduit has a base surface below the lower end and the pressure sensor is below the lower end.

12. The system of claim 11, wherein an area of the pressure sensor (Aₛₑₙₛₒᵣ) is less than a cross-sectional area of the measuring column (A_{column}).

13. The system of claim 11, further comprising a liquid temperature sensor adapted for measuring a temperature of liquid flowing through the system, wherein the liquid temperature sensor is coupled to the feed conduit.

14. The system of claim 1, further comprising an air pocket housing in fluid communication with the liquid exiting the measuring column, and a humidity sensor adapted for measuring vapor pressure within the air pocket housing.

15. The system of claim 14, further comprising a temperature sensor adapted for measuring a temperature within the air pocket housing.

16. The system of claim 14, wherein the air pocket housing is enclosed and isolated from an external atmosphere.

17. The system of claim 1, wherein the outlet is an upper end of the measuring column, and the liquid exiting the measuring column flows over upper edges of the measuring column.

18. The system of claim 17, wherein the upper end is encircled by an overflow housing adapted to capture liquid exiting the measuring column.

19. The system of claim 18, wherein the overflow housing includes a liquid collection portion below the upper end of the measuring column and an upper surface above the upper end.

20. The system of claim 19, further comprising a humidity sensor adapted for measuring a humidity of air within the overflow housing.

21. The system of claim 20, further comprising a temperature sensor adapted for measuring a temperature within the overflow housing.

22. The system of claim 1, further comprising a spout in liquid communication with the outlet, wherein a cross-sectional area of the spout (Aₛₚₒᵤₜ) is larger than a cross-sectional area of the measuring column (A_{MC}).

23. A method of determining a density of a liquid,
flowing a fluid through a measuring column having an inlet and an outlet, wherein the inlet is a distance (h) below the outlet;
detecting a pressure on the fluid at a location proximate the inlet, wherein the outlet is adapted such that the liquid exits the outlet to low pressure; and
calculating a fluid density based on at least the detected pressure and the distance (h).

24. The method of claim 23, wherein the fluid density is used to determine a parameter for operating a liquid desiccant regenerations.
